(19) United States
(12) Patent Application Publication
(10) Pub. No.: US 2007/0050188 A1
(43) Pub. Date: Mar. 1, 2007

(54) Tone contour transformation of speech

(75) Inventors: Colin Blair, Westleigh (AU); Kevin Chan, Ryde (AU); Christopher R. Gentle, Gladesville (AU); Neil Hepworth, Artarmon (AU); Andrew W. Lang, Epping (AU)

Correspondence Address: SHERIDAN ROSS P.C., 1560 BROADWAY, SUITE 1200, DENVER, CO, 80202, US

(73) Assignee: Avaya Technology Corp., Basking Ridge, NJ (US)

(21) Appl. No.: 11/213,139

(22) Filed: Aug. 26, 2005

(51) Int. Cl. G10L 11/04

(52) U.S. Cl. 704/207

(57) ABSTRACT

Tonal transformation of speech is provided. A tone applicable to a syllable of received speech is determined. A tonal contour applicable to said tone for a dialect of a listener is determined, and the syllable of received speech is altered to have said determined tonal contour. The altered speech may then be delivered to the listener.

### FIELD

The present invention is directed to the transformation of the tone contour of speech.

### BACKGROUND

There are approximately 1500 dialects in the Chinese spoken language that have been recorded. Chinese is a type of tonal language. A major obstacle to understanding the different dialects of Chinese is the differences in the tone contours in the pronunciation of words. In particular, in a tonal language, each spoken syllable requires a particular pitch of 10 voice in order to be regarded as intelligible and correct. For example, Mandarin Chinese has four tones, plus a “neutral” pitch. Cantonese Chinese has even more tones. These tones are described as “high, level,” high, rising,” “low, dipping,” and “high, falling,” respectively, and are known as the tone categories Ping, Shang, Qu and Ru. Furthermore, each tone is split into higher and lower tones, called Yin and Yang respectively. For instance, Ping is divided into YinPing and YangPing tones.

To mispronounce or miscomprehend the tone is to miss the Chinese word entirely. Therefore, in contrast to the English language, where pitch is used to a limited extent to indicate sentence meaning, for example to denote a question, Chinese uses tone as an integral feature of every word. Because of the differences in tone contours, it is difficult for a speaker of one dialect to understand a speaker of another dialect.

More particularly, tone contours describe the way a pitch varies over a syllable. The tone contour of a syllable can be represented by a set of numbers. These numbers can be visualized as the five horizontal lines in a stave of music. The lowest pitch is numbered 1, the next lowest is 2, and the highest is numbered 5. For instance, a tone contour of /213/ implies that the pitch of the tone dips and then rises. Level tone contours are /11/, /22/, /33/, /44/, and /55/. Examples of falling tone contours are /51/, /31/. Examples of rising tones are /13/ and /15/. As an example of differences in the tone contours that are applied to syllables as a result of speakers using different dialects, the tone contours used by a speaker from Beijing for the YinPing tone would be high flat (/55/), while the tone contours used by a speaker from Tianjin for the YinPing tone would be low and falling (/21/).

Studies have shown that the intelligibility between the different Mandarin Chinese dialects from various regions of China varies between mid 50% to low 70%. The mean correlation between Mandarin dialects is approximately 67%. This implies that even between native Mandarin speakers of different regions, significant barriers exist that prevents them from fully comprehending each other's spoken language. One of the reasons for this is the difference in tone contours.

### SUMMARY

In accordance with embodiments of the present invention, the tone contours of received speech are modified to reduce the differences between the speaker's dialect and the listener's dialect that are perceived by the listener. This is accomplished by detecting or being informed of the dialect used by a party providing speech and the dialect of the party receiving that speech. The speech may be analyzed to identify the syllable or syllables that it contains, and to determine the different tone contours applicable to the different dialects of the parties to the communication. A syllable included in the speech and the tone applied by the speaker can be identified by, for example, a voice recognition system or function. According to further embodiments, the word comprising the syllable can be identified in order to identify the tone. In addition, by referencing a tone contour table, the tone contours of each syllable applicable to the dialect of the listener can be identified. The tone of the syllable can then be modified from those of the speaker's dialect to those of the listener's dialect.

In accordance with further embodiments of the present invention, the dialects of the parties to a conversation are determined by analyzing the tone contours of set phrases voiced by the participants at each end point of a communication. In accordance with still other embodiments of the present invention, the modification to tone contours is applied based on a dialect selection made by a user of an endpoint, or is implied from the area code of the parties (for land lines) or from the location of the parties (for mobile lines). As used herein a dialect of a tonal language is understood to differ from another dialect of that language at least in the tonal contour applied to the spoken form of an otherwise like syllable.

Modification of speech to conform the tones from one dialect to another may be performed using tone contour transformation or correction. Tone contour transformation can be applied before the speech is sent to a recipient, to a recipient mailbox, or is stored in anticipation of later playback. In accordance with further embodiments of the present invention, a user may be prompted to approve modifications before they are applied to the user's speech. In addition to telephony applications, embodiments of the present invention can be applied in connection with broadcast applications, or in connection with recorded speech.

### BRIEF DESCRIPTION OF THE DRAWINGS

FIG. 1 is a block diagram of a communication system in accordance with embodiments of the present invention;

FIG. 2 is a block diagram of components of a communication or computing device or of a server in accordance with embodiments of the present invention;

FIG. 3 is a flowchart depicting aspects of a process for the tonal modification of speech in accordance with embodiments of the present invention;

FIG. 4 is a flowchart depicting additional aspects of a process for the tonal modification of speech in accordance with embodiments of the present invention; and

FIG. 5 depicts tonal contours for different tones according to different example Chinese dialects.

### DETAILED DESCRIPTION

In accordance with embodiments of the present invention, speech can be translated from a tone contour applied by a speaker in accordance with a particular dialect to another tone contour understood by a listener. Accordingly, embodiments of the present invention can facilitate the intelligibility of tonal languages between speakers of different dialects of such languages.

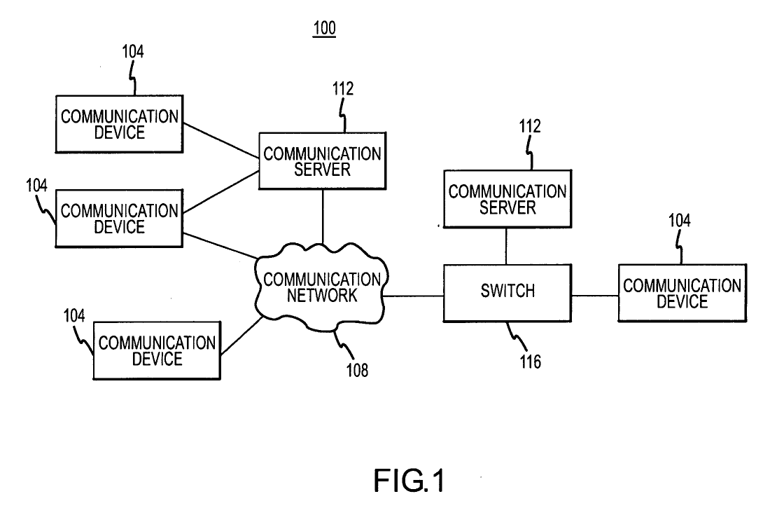

With reference now to FIG. 1, components of a communication system 100 in connection with which embodiments of the present invention have application are illustrated. In particular, a communication system with a number of communication or computing devices 104 may be interconnected to one another through a communication network 108. In addition, a communication system 100 may include or be associated with one or more communication servers 112 and/or switches 116.

As examples, a communication or computing device 104 may comprise a conventional wireline or wireless telephone, an Internet protocol (IP) telephone, a networked computer, a personal digital assistant (PDA), a television, radio or any other device capable of transmitting or receiving speech. In accordance with embodiments of the present invention, a communication or computing device 104 may also have the capability of analyzing and recording speech provided by a user for possible tone contour transformation. Alternatively or in addition, functions such as the analysis and/or storage of speech collected using communication or computing device 104 may be performed by a server 112 or other entity.

A server 112 in accordance with embodiments of the present invention may comprise a communication server or other computer that functions to provide services to client devices. Examples of servers 112 include PBX, voice mail, signal processor or servers deployed on a network for the specific purpose of providing tone contour transformation described herein. Accordingly, a server 112 may operate to perform or facilitate communication service and/or connectivity functions. In addition, a server 112 may perform some or all of the processing and/or storage functions in connection with the tone contour transformation functions of the present invention.

The communication network 108 may comprise a converged network for transmitting voice and data between associated devices 104 and/or servers 112. Furthermore, it should be appreciated that the communication network 108 need not be limited to any particular type of network. Accordingly, the communication network 108 may comprise a wireline or wireless Ethernet network, the Internet, a private intranet, a private branch exchange (PBX), the public switched telephony network (PSTN), a cellular or other wireless telephony network, a television or radio broadcast network, or any other network capable of transmitting data, including voice data. In addition, it can be appreciated that the communication network 108 need not be limited to any one network type, and instead may be comprised of a number of different networks and/or network types.

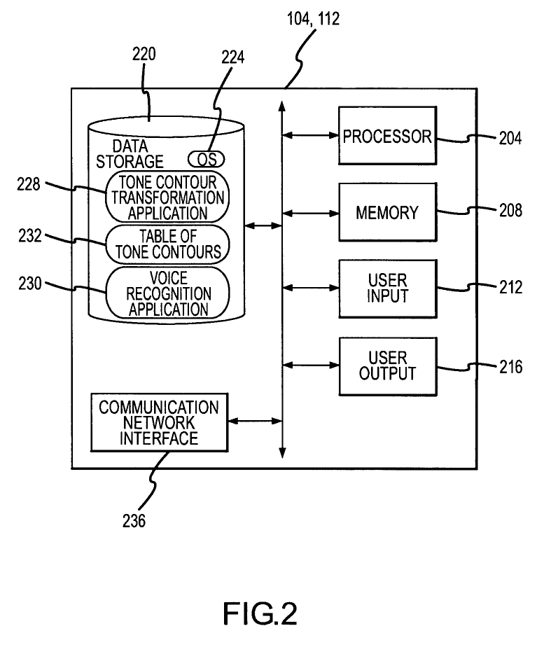

With reference now to FIG. 2, components of a communications or computing device 104 or of a server 112 implementing some or all of the tone contour transformation features described herein in accordance with embodiments of the present invention are depicted in block diagram form. The components may include a processor 204 capable of executing program instructions. Accordingly, the processor 204 may include any general purpose programmable processor, digital signal processor (DSP) or controller for executing application programming. Alternatively, the processor 204 may comprise a specially configured application specific integrated circuit (ASIC). The processor 204 generally functions to run programming code implementing various functions performed by the communication device 104 or server 112, including tone contour transformation operations as described herein.

A communication device 104 or server 112 may additionally include memory 208 for use in connection with the execution of programming by the processor 204 and for the temporary or long term storage of data or program instructions. The memory 208 may comprise solid state memory resident, removable or remote in nature, such as DRAM and SDRAM. Where the processor 204 comprises a controller, the memory 208 may be integral to the processor 204.

In addition, the communication device 104 or server 112 may include one or more user inputs or means for receiving user input 212 and one or more user outputs or means for outputting 216. Examples of user inputs 212 include keyboards, keypads, touch screens, touch pads and microphones. Examples of user outputs 216 include speakers, display screens (including touch screen displays) and indicator lights. Furthermore, it can be appreciated by one of skill in the art that the user input 212 may be combined or operated in conjunction with a user output 216. An example of such an integrated user input 212 and user output 216 is a touch screen display that can both present visual information to a user and receive input selections from a user.

A communication device 104 or server 112 may also include data storage 220 for the storage of application programming and/or data. In addition, operating system software 224 may be stored in the data storage 220. The data storage 220 may comprise, for example, a magnetic storage device, a solid state storage device, an optical storage device, a logic circuit, or any combination of such devices. It should further be appreciated that the programs and data that may be maintained in the data storage 220 can comprise software, firmware or hardware logic, depending on the particular implementation of the data storage 220.

Examples of applications that may be stored in the data storage 220 include a tone contour transformation application 228. The tone contour transformation application 228 may incorporate or operate in cooperation with a voice recognition application and/or a text to speech application. A voice recognition application 230, may operate as a means for identifying syllables or words in speech received from a user. In addition, the data storage 220 may contain a table or database of tone contours 232. In particular, the table or database 232 may contain, for each of a number of tones, the tone contours for such tones according to different dialects. Accordingly, a syllable received from a speaker of a first dialect may be transformed by the tone contour transformation application 228 from the speaker's dialect to the listener's dialect by transforming the tone contour of the syllable. A tone contour transformation application 228, voice recognition application and/or table of tone contours 232 may be integrated with one another, and/or operate in cooperation with one another. Furthermore, the tone contour transformation application 228 may comprise means for locating tones in the database 232 and means for altering a tone contour of a syllable or word in order to express a syllable or word according to a dialect understood by a listener. The data storage 220 may also contain application programming and data used in connection with the performance of other functions of the communication device 104 or server 112. For example, in connection with a communication device 104 such as a telephone or IP telephone, the data storage may include communication application software. As another example, a communication device 104 such as a personal digital assistant (PDA) or a general purpose computer may include a word processing application in the data storage 220. Furthermore, according to embodiments of the present invention, a voice mail or other application may also be included in the data storage 220.

A communication device 104 or server 112 may also include one or more communication network interfaces 236. Examples of communication network interfaces 236 include a network interface card, a modem, a wireline telephony port, a serial or parallel data port, radio frequency broadcast receiver or other wireline or wireless communication network interface.

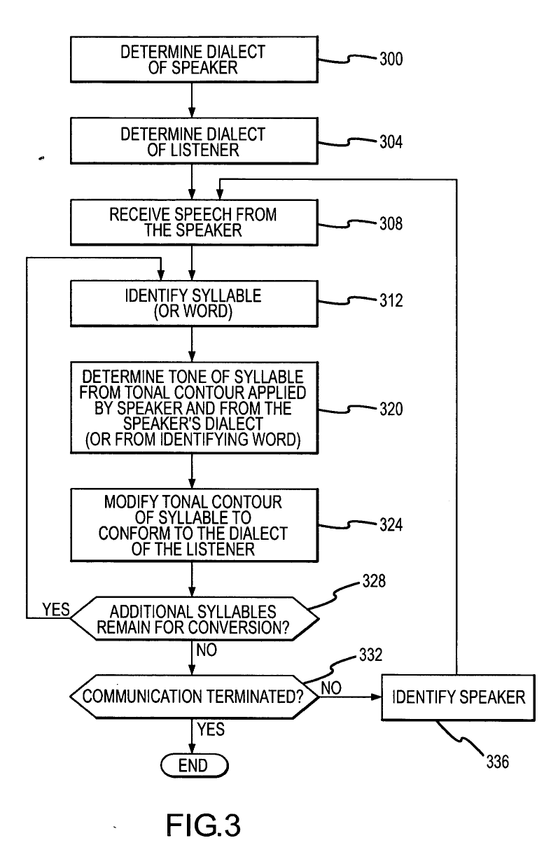

With reference now to FIG. 3, aspects of the operation of a communications device 104 or server 112 providing tone contour transformation of syllables or words in accordance with embodiments of the present invention are illustrated. At step 300, the dialect of a speaker is determined. In accordance with embodiments of the present invention, the dialect of the speaker is determined from information input by the speaker, such as a selection of a particular dialect. In accordance with other embodiments of the present invention, the dialect of the speaker may be determined by having the speaker voice a particular phrase, and then analyzing the received speech in order to determine the speaker's dialect. The dialect of the speaker may also be determined based on selections made by a third party such as an administrator or network personnel. In accordance with still other embodiments of the present invention, the dialect of the speaker may be inferred from the area code of the speaker or from the geographic location of the speaker. At step 304, the dialect of a listener is determined. The dialect of the listener may, like the dialect of the speaker, be determined based on a selection entered by the listener. In accordance with other embodiments of the present invention, the dialect of the listener may be determined by having the listener provide speech comprising a predetermined phrase, and then analyzing the received speech in order to determine the listener's dialect. The dialect of the listener may also be determined based on selections made by a third party, such as an administrator or network personnel. The dialect of the listener may also be inferred from the area code of the listener or from the geographic location of the listener.

At step 308, speech is received from the speaker. For example, the received speech may consist of a number of syllables comprising one or more words that may be held or stored in memory 208 or data storage 220 provided as part of a communication device 104 or server 112. Each syllable included in the received speech may then be identified (step 312). For example, the received speech may be parsed so that individual syllables can be located. As can be appreciated by one of skill in the art from the description provided herein, a voice or speech recognition application 230 may be used in connection with parsing speech in order to identify included syllables. Alternatively, the syllables or words included in the received speech may be recognized using a voice recognition application 230.

At step 320, the tone of the identified syllable can be determined. In particular, from the tonal contour applied to the syllable by the speaker, and from the speaker's dialect (determined at step 300), reference may be made to a table of tone contours 232 to determine the tone of the syllable. Alternatively, the tone of the syllable can be determined by identifying the word comprising the syllable. That is, where a syllable is identified, the tone contour applied to that syllable can be used to determine the tone, or where voice recognition is used to recognize the word comprising a syllable, the identification of the word can be used to at least identify the tone contour to be applied to the syllable in order to transform the tone to the dialect of the listener. After determining the tone of the syllable, the tonal contour of that syllable is modified to conform to the dialect of the listener (step 324).

In accordance with embodiments of the present invention, tone contour transformation may be applied through digital manipulation of the recorded speech. For example, as known to one of skill in the art, speech may be encoded using vocal tract models, such as linear predictive coding. For a general discussion of the operation of vocal tract models, see Speech digitization and compression, by Michaelis, P.R., available in the International Encyclopedia of Ergonomics and Human Factors, pp. 683-685, W. Warkowski (Ed.), London: Taylor and Francis, 2001, the entire disclosure of which is hereby incorporated by reference herein. In general, these techniques use mathematical models of the human speech production mechanism. Accordingly, many of the variables in the models actually correspond to the different physical structures within the human vocal tract that vary while a person is speaking. In a typical implementation, the encoding mechanism breaks voice streams into individual short duration frames. The audio content of these frames is analyzed to extract parameters that “control” components of the vocal tract model. The individual variables that are determined by this process include the overall amplitude of the frame and its fundamental pitch. The overall amplitude and fundamental pitch are the components of the model that have the greatest influence on the tonal contours of speech, and are extracted separately from the parameters that govern the spectral filtering, which is what makes the speech understandable and the speaker identifiable. Tone contour transformation in accordance with embodiments of the present invention may therefore be performed by applying the appropriate delta to the original amplitude and pitch parameters detected in the speech. Because changes are made to the amplitude and pitch parameters, but not to the spectral filtering parameters, the transformed voice stream will still generally be recognizable as being the original speaker's voice. The transformed speech may then be sent to the recipient address, stored, broadcast or otherwise released to the listener. For example, where the speech is received in connection with leaving a voice mail message for the recipient, sending the transformed speech may comprise releasing the transformed speech to the recipient address.

At step 328, a determination may be made as to whether syllables in the received speech remain to be transformed or converted from the speaker's dialect to the dialect of the listener. If additional syllables remain for conversion, the process may return to step 312, and the next syllable may be identified. If no syllables in the received speech remain for conversion, a determination may next be made as to whether the communication session has been terminated (step 332). If the communication is ongoing, additional speech will be received. Accordingly, the speaker providing the additional speech is identified (step 336) and that speaker's speech is received at (step 308) for processing and transformation. If the communication has been terminated, the process may end. Furthermore, the process of identifying syllables within speech and performing tone contour transformation as described herein in order to make that speech more intelligible to the listener can be applied in connection with multi-party communications.

Optionally, a determination may be made as to whether the user has approved of the suggested substitute. For example, the user may signal assent to a suggested substitute by providing a confirmation signal through a user input 212 device. Such input may be in the form of pressing a designated key, voicing a reference number or other identifier associated with a suggested substitute and/or clicking in an area of the display corresponding to a suggested substitute. Furthermore, assent to a suggested substitution can comprise a selection by a user of one of a number of potential substitutions that have been identified by the tonal transformation application 228.

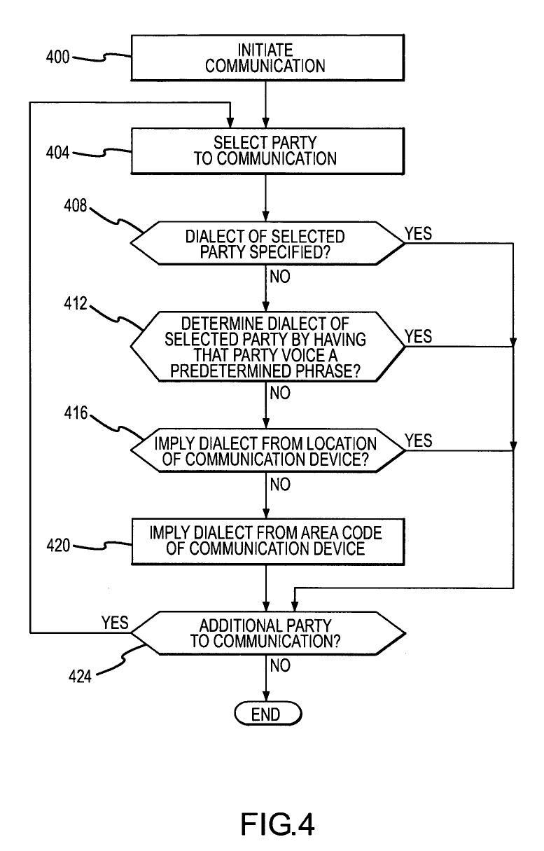

With reference now to FIG. 4, aspects of a process for the identification of the dialect of a user or a party to a communication in accordance with embodiments of the present invention are illustrated. At step 400, a communication is initiated. The initiation of a communication may, for example, comprise establishing contact between two communication devices 104 over the public-switched telephone network, the Internet or a combination of network types. A further example of the initiation of a communication is the receipt of speech for later broadcast or broadcast in real time, for example over a radio frequency network.

A party to the communication may then be selected (step 404). A determination may then be made as to whether the dialect of the selected party has been specified (step 408). The specification of a party's dialect may comprise receiving from that party a selection of a preferred dialect. Alternatively, such information may be sent by a network administrator or other entity, to be used with any communications between a particular communication device 104 and another communication device 104. As yet another example, the dialect of the selected party may be specified by that party upon initiating (or responding to the initiation of) a communication link with another party.

If the dialect of the selected party has not been specified, a determination may be made as to whether the dialect of the selected party can be determined by having that party voice a predetermined phrase (step 412). For example, by having a party voice one or more known syllables, a tone contour transformation application 228 and a voice recognition application 230 can, with reference to a table of tone contours 232, determine the dialect of the speaker from the particular tone contour applied to the specified syllable or syllables.

If the dialect of the speaker cannot be determined from voicing a predetermined phrase, the dialect of the selected party may be implied from the geographic location of that party's communication device 104 (step 416). For example, geographic location information available with respect to a mobile communication device 104, such as a cellular telephone, may be used to imply the dialect of the party.

If the dialect to be applied cannot be implied from the geographic location of a communication device 104, the dialect can be implied from the area code of the communication device 104 being used by the selected party. After a dialect of the selected party has been determined or implied at any of steps 408 through 420, a determination may be made as to whether there is an additional party for which a dialect needs to be determined (step 424). If the dialect of any party remains to be determined, the process may return to step 404. If a dialect has been determined for each of the parties, the process may end.

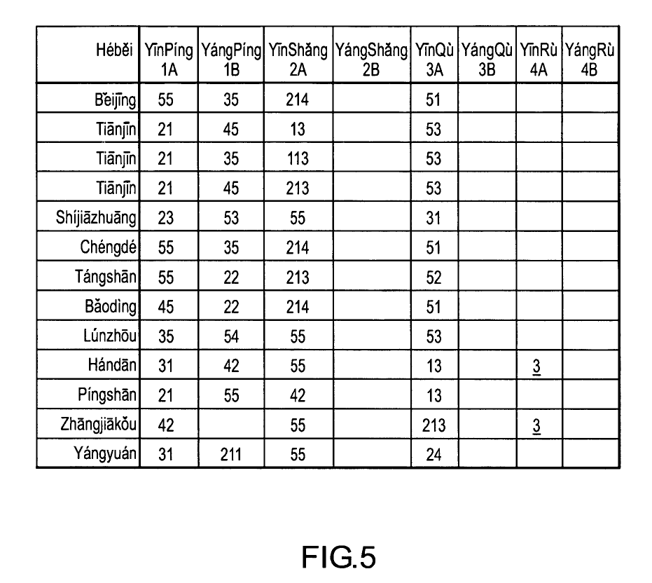

With reference now to FIG. 5, the tonal contours for different tones according to different example Chinese dialects are illustrated. In particular, the table shows the Mandarin tone contours for the Héb\check{e}i region, which encompasses Beijing. As shown in the figure, a Mandarin speaker from Beijing will pronounce the YinPing tone as high flat (/55/) while a Mandarin speaker from Tianjin would pronounce the same tone as low and falling (/21/). Note that, over time, some tones have merged into other tones. For example, in FIG. 5 none of the included dialects has YangShang, YangQu or YangRu tones. Furthermore, only two of the illustrated dialects has the YinRu tone. Accordingly, where a syllable has one tone according to the dialect of the speaker and a different tone according to the dialect of the listener, such correspondence may be reflected in the table of tone contours 232 in order to ensure a correct transformation.

In accordance with embodiments of the present invention, various components of a system capable of performing tone contour transformation of speech can be distributed. For example, a communication device 104 comprising a telephony endpoint may operate to receive speech and command input from a user, and deliver output to the user, but may not perform any processing. According to such an embodiment, processing of received speech in connection with tone contour transformation is performed by a server 112. In accordance with still other embodiments of the present invention, tone contour transformation functions may be performed entirely within a single device. For example, a communication device 104 with suitable processing power may analyze the speech and perform tone contour transformation. According to these other embodiments, when the communication device 104 releases or transmits the speech to the recipient, that speech may be delivered to, for example, the recipient's answering machine, to a voice mailbox associated with a server 112, or to a radio receiver.

In accordance with embodiments of the present invention, tone contour transformation as described herein may be applied in connection with real-time, near real-time or off-line applications, depending on the processing power and other capabilities of communication devices 104 and/or servers 112 used in connection with the application of the tone contour transformation functions. In addition, although certain examples described herein are related to voice telephony applications, embodiments of the present invention are not so limited. For instance, tone contour transformation as described herein can be applied to any recorded speech and even speech delivered to a recipient at close to real time. In addition, embodiments of the present invention may be used in connection with recorded speech or with broadcast applications. Furthermore, although certain examples provided herein have discussed the use of tone contour transformation in connection with dialects within the Chinese language, it can be applied to dialects within other tonal languages, such as Thai and Vietnamese. Embodiments of the present invention can also be used to correct mispronunciations by a non-native speaker, accordingly a “dialect” may include a mispronunciation.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with the various modifications required by their particular application or use of the invention. It is intended that the appended claims be construed to include alternative embodiments to the extent permitted by the prior art.

What is claimed is:

1. A method for the tonal transformation of speech, comprising:
receiving speech from a first user including a first syllable spoken in a first dialect;
identifying said first syllable included in said received speech;
determining a tonal contour of said first syllable;
determining a tonal contour for said first syllable according to a second dialect spoken by a second user;
modifying said first syllable included in said received speech to create modified speech, wherein said modified speech has said tonal contour for said first syllable according to said second dialect spoken by said second user.

2. The method of claim 1, further comprising:
delivering said modified speech to said second user.

3. The method of claim 1, further comprising:
determining said first dialect spoken by said first user;
determining said second dialect spoken by said second user.

4. The method of claim 3, wherein said determining said first dialect spoken by said first user and said second dialect spoken by said second user comprises receiving a signal from at least one of said first user and said second user indicating at least one of said first and second dialects.

5. The method of claim 3, wherein said determining a dialect spoken by at least one of said first user and said second user comprises receiving a pronunciation of at least a first word from said at least one of said first user and said second user and determining a tonal contour applied to said at least a first word.

6. The method of claim 5, wherein said at least a first word is predetermined.

7. The method of claim 5, wherein said at least a first word is identified using a speech recognition application.

8. The method of claim 3, wherein said determining a dialect spoken by at least one of said first user and said second user comprises inferring a dialect from at least one of an area code and a geographic location of a communication device associated with said at least one of said first and second user.

9. The method of claim 1, wherein said determining a tonal contour comprises:
determining a tone of said first syllable;
referencing a tone contour table;
locating in said tone contour table a tonal contour applicable to said determined tone according to said second dialect spoken by said second user.

10. The method of claim 1, wherein said first syllable is identified using a speech recognition application.

11. A system for the tonal modification of speech, comprising:
a user input, operable to receive speech;
a memory, wherein said memory stores tonal contours for each of a plurality of tones and for each of a plurality of dialects including at least first and second dialects;
a processor, wherein in response to receipt of speech comprising at least a first received syllable having a first tonal contour according to said first dialect of a language, said first received syllable is modified to form a first modified syllable having a second tonal contour according to said second dialect of said language.

12. The system of claim 11, wherein said memory stores said tonal contours in a table, and wherein said table maps a tone of said first received syllable to a tonal contour applicable for said first received syllable according to said second dialect of said language.

13. The system of claim 11, further comprising:
a communication interface interconnected to said processor;
a communication network interconnected to said communication interface and to a plurality of addresses, wherein said first modified syllable is released for delivery to a recipient address.

14. The system of claim 13, wherein said user input receives said speech further comprising:
a user output, wherein said first modified syllable is presented to a user.

15. The system of claim 14, wherein said user output includes a speaker, and wherein said first modified syllable is presented to said user as speech.

16. The system of claim 14, further comprising:
a first communication device, wherein said user input is provided as part of said first communication device; and
a second communication device, wherein said user output is provided as part of said second communication device.

17. The system of claim 16, wherein said first and second communication devices comprise telephony devices, said system further comprising:
a server, wherein said server comprises said memory and said processor.

18. A system for modifying a dialect of tonal speech, comprising:
means for receiving speech as input;
means for determining a tone of a syllable included in received speech;
means for storing tonal contours associated different tones for a number of different dialects of a language;
means for altering a tonal contour of at least a first syllable included in said first received speech to create transformed speech, wherein a tonal contour of said at least a first syllable is changed from a tonal contour from a tonal contour for a tone of said first syllable corresponding to a first dialect of a first language to a tonal contour for said tone of said first syllable corresponding to a second dialect of said first language.

19. The system of claim 18, further comprising:
means for outputting said transformed speech to a user.

20. The system of claim 18, further comprising:
means for delivering said transformed speech to a recipient address.
